(19) United States
(12) Patent Application Publication
(10) Pub. No.: US 2004/0095894 A1
(43) Pub. Date: May 20, 2004

(54) Method and system for handling connection information in a communication network

(76) Inventors: Jaana Eloranta, Helsinki (FI); Giorgi Gulbani, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/345,969

(22) Filed: Jan. 17, 2003

Related U.S. Application Data
(60) Provisional application No. 60/426,382, filed on Nov. 15, 2002.

(51) Int. Cl. H04L 12/26

(52) U.S. Cl. 370/252

(57) ABSTRACT

A method for handling connection information in a communication network, including intercepting a data packet sent from/to a target, composing a header for the intercepted data packet, and sending the header to a monitoring entity. Instead of composing the header and forwarding it, the method may alternatively include examining the intercepted data packets with respect to specific information, determining whether an predetermined event with respect to the specific information has occurred, and, if the predetermined event has occurred, sending a corresponding message to a monitoring entity, thereby causing a more flexible handling of connection information.

The present application claims the benefit of priority of Provisional Application No. 60/426,382, filed Nov. 15, 2002, the contents of which are incorporated herein by reference.

### FIELD OF THE INVENTION

This invention relates to a method and a system for handling connection information in a communication network.

### BACKGROUND OF THE INVENTION

In particular, the invention relates to lawful interception within a communication network system which includes one or more network entities like a GSM/UMTS system or method.

Lawful interception of telecommunications is required by law in most countries. See Table 1 for classification of currently collected interception data. In packet switched GSM and UMTS networks lawful interception considers binary data exchanged between a mobile station and an access point. More specific, the SGSN and/or GGSN network elements in GRPS/3G core network collect the exchanged data on the request of an ADMF, and send it to DF that forwards the data to a lawful enforcement monitoring facility LEMF.

The following table 1 illustrates currently collected IRI and CC data in Circuit switched and Packet switched environment.

| | IRI | CC |
|---|---|---|
| Circuit | source of the call | content of the call |
| switched | destination of the call | |
| | location of the caller | |
| | length of the call | |
| | type of the call | |
| Packet | target's IP address | content of the connection |
| switched | location | containing |
| | | source and destination |
| | | IP addresses |
| | | length of the exchanged |
| | | data |
| | | type of the connection |

Two types of interception data are collected. The interception related information IRI contains signalling information such as the start and end of a PDP context, for example. On the other hand, the contents of communication CC contains the actual user data exchanged, say IP packets from an e-mail. An LEA obtains an authorisation to intercept IRI more easily, in order to intercept CC more grave accusations must be the case.

Packet switched IRI data differs significantly from circuit-switched IRI data, see Table 1. In circuit switched environment, the called party as well as the length and type of the call are included to IRI data. In packet switched environment the source and the destination IP addresses and the length and the type of the connection can be extracted only from the initial CC data, transferred across the packet switched GSM or UMTS networks. This is mostly due to (historical) technical reasons.

In particular, the field of the invention is related to a handover of a Lawful Interception (LI) data from LI entities, e.g. nodes that support LI Delivery Function (DF) and LI Mediation Function (MF), to a Law Enforcement Monitoring Facility (LEMF) of a Law Enforcement Agency (LEA). Such network entities are capable of exchanging LI target's data, such as Contents of Communication (CC), and Interception Related Information (IRI) through logical connections, such as Handover Interface port 2 (HI2) and Handover Interface port 3 (HI3). DF and MF for HI2 port (DF2/MF2) are logically separated from DF and MF for HI3 (DF3/MF3).

In the following, the structure regarding handover of Lawful Interception data is described in more detail by referring to the respective 3GPP specification (TS 33.108v5.1.0).

A functional block diagram showing the handover interface HI is illustrated in FIG. 1. The handover interface HI comprises three Handover Interface ports HI1, HI2 and HI3. HI1 serves to convey administrative information. The links for such administrative information are indicated by dotted arrows. HI1 is connected to the NWO/AccessProvider/SvP's (Network Operator/Access Provider/Service Provider's) administrative function, which is indicated by ADMF in the figure. The ADMF controls functions of the IRI mediation function (IRI MF) and the CC mediation function (CC MF). In addition, the ADMF has access to the network internal functions via an Internal Network Interface (INI). These functions are indicated in the figure by the inner circle, whereas the outer circle indicates the whole NWO/AccessProvider/SvP's domain.

HI2 serves to convey IRI (intercept related information) which is provided from an Internal Interception Function (IIF) of the network via the INI and the IRI MF. HI3 serves to convey CC (Content of Communication) which is provided from the IIF via the INI and the CC MF.

The LEA domain is indicated by the thick line on the right side of the figure. In particular, the LEMF as a part of the LEA domain receives IRI and CC via HI2 and HI3, respectively, and also handles the administrative information via HI1.

The LI target is a communication entity, such as IMSI, MSISDN, IMEI or IP interface, which may be used by a suspect.

The access point is e.g. for a corporate network that offers its employees Intranet services. It can also be an ISP (Internet Service Provider) service point that offers Internet services.

However, presently the IRI events do not contain information about the service used by a user, which, nevertheless, may be important when observing a target.

Heretofore, this was only possible by analysing the CC data. However, sometimes it is impossible to analyse the CC data and more often the analysis results are too late when obtained.

In addition, LEA may be entitled to receive only IRI data associated with a given target. That is, in some cases the LEA is not entitled to receive CC data such that the used service or other information may be obtained.

In such case, i.e., when the LEA is only entitled to receive IRI data, the LEA will be informed once the target activates a telecommunication service, such as activating a PDP context via the Packet Switched (PS) domain of a GSM/UMTS system. However, the LEA may still wish to know how actively the target is using services via the PS domain. For instance, how often the target sends/receives messages (SMS, email, etc.).

This kind of functionality is not supported by current HI specifications.

That is, presently it is not possible to obtain additional information as service information or traffic information without examining the CC data.

Thus, as described above, heretofore it is only possible to obtain general IRI events (sent via HI2) or detailed CC data (sent via HI3).

This is in particular disadvantageous in a case in which some more detailed information is required as can be given by the currently defined IRI events, but obtaining of detailed CC data is not possible or permitted.

Therefore, the prior art has the drawback that no flexible handling of connection information is possible.

### SUMMARY OF THE INVENTION

Thus, the object underlying the present invention resides in solving the above-described problems such that an interception can be handled more flexibly and it is possible to obtain more information about a target even when the payload of intercepted data packets may not be examined.

According to a first aspect of the invention, this object is solved by a method for handling connection information in a communication network. The method includes the steps intercepting a data packet sent from/to a target, composing a header for the intercepted data packet, and sending the composed header to a monitoring entity.

Alternatively, the object is solved by a system for handling connection information in a communication network. The system includes an intercepting means for intercepting a data packet sent from/to a target, a composing means for composing a header of the intercepted data packet, and a sending means for sending the composed header to a monitoring entity.

In this way, only the composed header is transmitted to the monitoring entity (e.g., LEA), without sending the actual content of the data packet, i.e., the payload.

The headers of a data packet contain more information than the heretofore defined IRI events. Hence, a more flexible handling of the connection information is possible, even if accessing of the payload of the data packets is not possible or permitted.

Furthermore, the header may be composed and the payload of the intercepted data packet may be discarded. That is, the intercepted data packet may be conveyed up to a point to which such a transport is allowed (e.g., a delivery function/mediation function (DF/MF)). Then, the payload is simply discarded, i.e., deleted, such that the composed headers may be easily transmitted to the monitoring entity.

The composed header may be sent to the monitoring entity via an interface dedicated to sending contents of communication messages. The interface may be the HI3 interface, as defined in the specification 3GPP TS 33.108v5.1.0.

Alternatively, the composed header may be sent to the monitoring entity via an interface dedicated to sending interception related information messages. The interface may be the HI2 interface, as defined in the specification 3GPP TS 33.108v5.1.0.

The intercepted data packet may be transmitted via a X interface. In this case, upon intercepting a X contents of communication (CC) message is assembled by adding a X interface header to the intercepted data packet, and upon composing the header, the intercepted data packet may be extracted from the X contents of communication (CC) message, a HI contents of communication header may be created and the intercepted data packet may be discarded. That is, the HI CC header forms the HI CC message. Thus, the case can be handled in which a complete data packet is to be sent via the X interface, but is not to be sent via the HI interface.

The X interface in question may be a X3 interface, and the HI interface may be a HI3 interface.

The composed header may be included in an interception related information (IRI) message and sent over a HI2 interface to the monitoring entity.

Moreover, a frequency of services used by the intercepted target may be examined by the monitoring entity based on the received composed headers. For example, it may be examined, how often a particular service like e-mail or a service offered by a specific service provider is used.

Moreover, an user data header (or a plurality of user data headers) may be extracted from the intercepted data packet and added to the composed header to be sent to the monitoring entity.

That is, when composing the header (before e.g., discarding the payload), it can be looked into the packet whether some specific information (e.g., IP addresses, special service indications and the like) are included in the data packet, i.e., in the user data headers of the actual IP packet sent over the internet, for example. Such a user data header may be an IP header, an UDP/TCP header or upper layer headers inserted by the user's application. In this way, the specific information derivable from the headers may be included into the header to be sent to the monitoring entity.

Thus, the flexibility of handling the interception information can be further increased, since in addition particular items can be gathered from the data packets without that it would be necessary to sent the whole data packet.

According to a further aspect of the invention, the above object is solved by a method for handling connection information in a communication network. The method includes intercepting data packets sent from/to a target, examining the intercepted data packets with respect to specific information, determining whether an predetermined event with respect to the specific information has occurred, and if the predetermined event has occurred, sending a corresponding message to a monitoring entity.

The above object is also solved by a system for handling connection information in a communication network. The system includes an intercepting unit for intercepting data packets sent from/to a target, and a controlling unit adapted to examine the intercepted data packets with respect to specific information, to determine whether an predetermined event with respect to the specific information has occurred, and to send, if the predetermined event has occurred, a corresponding message to a monitoring entity.

In this way, the intercepted data packets are examined for specific information, which may be service information or traffic information. When a predetermined event (e.g., exceeding a threshold in case of traffic information or changing of a service) occurs, the message is sent.

Thus, it is possible to look for specific information which are interesting for a monitoring entity (e.g., LEA). Hence, it is not necessary to examine whole intercepted user data packets (including the payload or actual data) in order to obtain the specific information in the monitoring entity, which might even not be possible when the monitoring entity is not permitted to look at the content of the data packets.

Hence, a more flexible handling of connection information in a communication network is possible.

In addition, it is possible to reduce the traffic load between the intercepting network node and the monitoring entity since it is not necessary to forward the whole data packets. Moreover, it is not necessary to send one event for each data packet.

The specific information may contain service information, and the predetermined event may be the use of a new service. That is, in case the target starts using a new service (either on starting a communication session or on changing the service during a session), a message is sent to the monitoring entity.

Alternatively, the specific information may contain traffic information, and the predetermined event may be exceeding a predefined threshold of the amount of traffic. That is, in case the amount of traffic caused by the target exceeds the threshold, a corresponding message is sent to the monitoring entity.

The predefined event can be a timer expiration when e.g. traffic information needs to be reported once an hour.

In all cases, only the information interesting for the monitoring entity is actually transmitted to the monitoring entity. That is, if the monitoring entity is only interested in the services used by the target or which amount of traffic is caused by the target, it is not necessary to forward all intercepted packets to the monitoring entity. This reduces the operation load and traffic load within the network nodes included in the interception.

The message sent to the monitoring entity may be sent via an interface dedicated to sending interception related information. For example, this interface may be a HI2 interface.

The message to be sent to the monitoring entity may form a specific interception related information (IRI) event. That is, by defining such an IRI event, the message can be handled together with other IRI events already handled in interception.

Moreover, headers of an intercepted data packet may be extracted, the extracted header may be included into the message to be sent to the monitoring entity. In this way, the contents of communication (CC) header may be included in an IRI message, which is forwarded via a different interface (namely the HI2 interface) instead of sending it via the interface dedicated to CC data (i.e., HI3 interface). Hence, handling of the interception information can be more flexible.

The examination of intercepted data packets with respect to specific information may be performed by examining the extracted headers. That is, if it is known that the header contains the specific information (e.g., some service indication), only the extracted header is examined such that an examination of the payload is not necessary. In this way, the operation load can be reduced.

The examining may be performed by a packet lookup function of a network node (e.g., GSN). Thus, the traffic and the operation load on the sending means (e.g., DF2) may be reduced.

Alternatively, the intercepted packets may be delivered from a contents of communication (CC) duplicator function to a delivery function (e.g., DF2) such that the examining may be performed by the delivery function. In this way, the operation load on the network node (e.g., GSN) may be reduced.

A means for performing the interception may be a contents of communication duplicator implementation of a network node. A means for performing the composing the headers may be a delivery function (DF) and/or mediation function (MF) at a handover interface (HI). Also, a means for controlling the extraction and creation the message indicating a predetermined event, and/or a means for sending the data to the monitoring entity (which may be LEA) may be the delivery function (DF) and/or mediation function (MF) of the handover interface.

In addition, the invention proposes a method for handling connection information in a communication network. The method comprises: accessing a subscriber specific database of a target within a serving network node, extracting information from the subscriber specific database with respect to specific information, and sending the extracted information to a monitoring entity.

The subscriber specific database may be a Charging Data Record (CDR) of the target. In this way, an already existing database can be utilized to obtain information about a target. Thus, it is not required to perform intercepting of all data packets of the target.

The specific information may comprise exchanged data volume and/or duration of the connection.

### BRIEF DESCRIPTION OF THE DRAWINGS

FIG. 1 shows the principle of interception and in particular a LI Handover Interface HI,

FIG. 2 shows a flow chart illustrating a procedure according to a first embodiment of the invention,

FIG. 3(a) to 3(d′) illustrate different formats of headers according to the first embodiment,

FIG. 4 illustrates a procedure of creating a PDP context related IRI event,

FIG. 5 shows a procedure of creating a Service Changed IRI Event according to a second embodiment of the invention,

FIG. 6 illustrates signal flows according to the invention used in the first and second embodiments and modifications thereof by referring to eight cases 1 to 8,

FIG. 7(a) to 7(d) show different data formats used in the cases 1 and 2,

FIG. 8 illustrates cases 1 to 4 in which the LEMF receives IRI events, and

FIG. 9 illustrates cases 5 to 9, in which the LEMF receives CC header information.

### DESCRIPTION OF PREFERRED EMBODIMENTS

In the following, preferred embodiments are described by referring to the enclosed drawings.

Before describing the embodiments in detail, in the following the used terms and definition are listed:

Access point (AP): point of entry or means of entry to a circuit. In general packet radio service (GPRS), an interface between the GPRS backbone network and external packet data networks.

Access provider: e.g. the NWO that makes accessing possible.

CC message: contents of communication (CC) encapsulated by interface specific CC header. System employs X3 interface CC header and HI3 CC header.

Communication: Information transfer according to agreed conventions.

Content of communication (CC): information exchanged between two or more users of a telecommunications service, excluding intercept related information. This includes information which may, as part of some telecommunications service, be stored by one user for subsequent retrieval by another.

Handover interface (HI): physical and logical interface across which the interception measures are requested from network operator/access provider/service provider, and the results of interception are delivered from a network operator/access provider/service provider to a law enforcement monitoring facility.

Identity: technical label which may represent the origin or destination of any telecommunications traffic, as a rule clearly identified by a physical telecommunications identity number (such as a telephone number) or the logical or virtual telecommunications identity number (such as a personal number) which the subscriber can assign to a physical access on a case-by-case basis.

Interception: action (based on the law), performed by an network operator/access provider/service provider, of making available certain information and providing that information to a law enforcement monitoring facility.

Intercept related information (IRI): collection of information or data associated with telecommunication services involving the target identity, specifically communication associated information or data (e.g. unsuccessful communication attempts), service associated information or data (e.g. service profile management by subscriber) and location information.

Interception subject: person or persons, specified in a lawful authorization, whose telecommunications are to be intercepted.

Law Enforcement Agency (LEA): organization authorized by a lawful authorization based on a national law to request interception measures and to receive the results of telecommunications interceptions.

Law Enforcement Monitoring Facility (LEMF): law enforcement facility designated as the transmission destination for the results of interception relating to a particular interception subject.

Lawful authorization: permission granted to a LEA under certain conditions to intercept specified telecommunications and requiring co-operation from a network operator/access provider/service provider. Typically this refers to a warrant or order issued by a lawfully authorized body.

Lawful Interception (LI): see interception.

Mediation device: equipment, which realizes the mediation function.

Mediation Function (MF): mechanism which passes information between a network operator, an access provider or service provider and a handover interface, and information between the internal network interface and the handover interface.

Network operator: operator of a public telecommunications infrastructure which permits the conveyance of signals between defined network termination points by wire, by microwave, by optical means or by other electromagnetic means.

Protocol data unit (PDU): information unit passed between peer entities.

Result of interception: information relating to a target service, including the content of communication and intercept related information, which is passed by a network operator, an access provider or a service provider to a law enforcement agency. Intercept related information shall be provided whether or not call activity is taking place.

Service information: information used by the telecommunications infrastructure in the establishment and operation of a network related service or services. The information may be established by a network operator, an access provider, a service provider or a network user.

Service provider (SvP): natural or legal person providing one or more public telecommunications services whose provision consists wholly or partly in the transmission and routing of signals on a telecommunications network. A service provider needs not necessarily run his own network.

SMS: Short Message Service gives the ability to send character messages to phones. SMS messages can be MO (mobile originate) or MT (mobile terminate).

Target identity: technical identity (e.g. the interception's subject directory number), which uniquely identifies a target of interception. One target may have one or several target identities.

Target service: telecommunications service associated with an interception subject and usually specified in a lawful authorization for interception.

Telecommunications: any transfer of signs, signals, writing images, sounds, data or intelligence of any nature transmitted in whole or in part by a wire, radio, electromagnetic, photoelectronic or photo-optical system.

X-interface: Interface between intercepting GSN and DF/MF. A detailed X-interface definition can be found in specification 3GPP TS 33.107v5.4.0

In addition, in the following abbreviations are also used in this description:

| | |
|---|---|
| ADMF | Administration Function (controls intercepting |
| | GSN and DF/MF) |
| CGI | Cell Global Identity |
| DF | Delivery Function |
| DF2 | Delivery Function for HI2 port |
| DF3 | Delivery Function for HI3 port |
| ftp | File Transfer Protocol |
| GGSN | Gateway GPRS Support Node |
| GPRS | General Packet Radio Service |
| GSM | Global System for Mobile communications |
| GSN | GPRS Support Node, SGSN or GGSN |
| GTP | GPRS Tunnel Protocol |
| HI1 | Handover Interface Port 1 (for Administrative |
| | Information) |
| HI2 | Handover Interface Port 2 (for Intercept |
| | Related Information) |
| HI3 | Handover Interface Port 3 (for Content of |
| | Communication) |
| HTTP | HyperText Transfer Protocol |
| IA | Interception Area |
| IE | Information Element |
| IMEI | International Mobile station Equipment Identity |
| IMSI | International Mobile Subscriber Identity |
| IP | Internet Protocol |
| MF2 | Mediation Function for HI2 port |
| MF3 | Mediation Function for HI3 port |
| MS | Mobile Station |
| MSISDN | Mobile Subscriber ISDN Number |
| NSAPI | Network layer Service Access Point Identifier |
| NWO | Network Operator |
| PDP | Packet Data Protocol |
| PLMN | Public land mobile network |
| SGSN | Serving GPRS Support Node |
| TEID | Tunnel Endpoint Identifier |
| UMTS | Universal Mobile Telecommunication System |
| URL | Uniform Resource Locator |
| X2 | Interface between intercepting node and DF2/MF2 |
| X3 | Interface between intercepting node and DF3/MF3 |

First Embodiment

In the following, a first embodiment of the invention is described. Basically, according to the first embodiment a header is composed from an intercepted data packet, and only this composed header is sent to the LEMF (i.e., the monitoring entity).

Thus, according to this first embodiment, the new type of IRI data is sent via the HI3 interface. Namely, a CC header without the target's data is sent via the HI3 interface. This procedure according to the first embodiment is described in detail in the following.

As described in the introductory part, there may be cases in which the LEA is only entitled to receive IRI data associated with a given target and not corresponding CC data. In such case, the LEMF will be informed once the target activates a telecommunication service, such as activating a PDP context via the Packet Switched (PS) domain of a GSM/UMTS system. However, the LEA may still wish to know how actively the target is using services via the PS domain, for instance, how often the target sends/receives messages (SMS, email, etc.). According to the prior art, this kind of functionality is not supported by current HI specifications.

Thus, according to the first embodiment, it is possible to provide a LEA with the data on how often a target is using telecommunication services via PS domain of the GSM/UMTS system, when LEA is entitled to receive only IRI data associated with a given target.

In particular, the first embodiment provides a possibility to a LEMF to monitor the activity of the target in the following way. In case authorization for only the IRI interception has been granted to a LEA, LEMF would need to receive a special type of the IRI data, which would provide for the estimation of the data volume exchanged by target, and the duration and intensity of the data exchange session(s).

Such type of IRI has not been defined according to the prior art. The reason for this was that only DF3/MF3 may obtain the relevant IRI data from CC, without sending the actual CC data to LEMF. However, HI3 definition allowed only for the CC delivery to LEMF, and not the IRI delivery.

According to the first embodiment, this problem is solved by modifying the definition of the HI3 port. In the modified HI3 definition a new IRI type and its usage is defined.

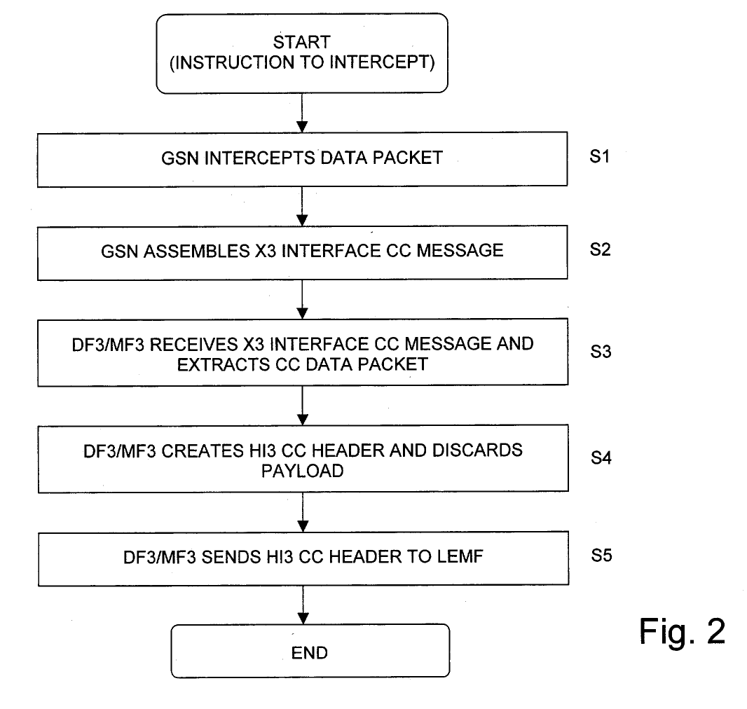

The process according to the first embodiment is described in the following by referring to the flowchart shown in FIG. 2. The process starts when the ADMF instructs a GSN to intercept (copy) target's data, which makes up the initial CC packet (step S1). The GSN assembles an X3-interface CC message by adding an X3 interface header to the copy of the target's initial CC data packet (step S2). The X3 interface CC message is sent via the X-interface (i.e., in this case via the X3 interface) to the DF3/MF3.

When the DF3/MF3 receives X3 interface CC message, the DF3/MF3 extracts the initial CC data packet from the message (step S3), and creates a HI3 CC header. Note, that the HI3 CC header would not necessarily be identical to the X3 CC header. For instance, those headers may be encoded differently. After that, according to the prior art the DF3/MF3 encapsulate the initial CC data packet by HI3 CC header, thus forming an HI3 CC message. However, according to the present embodiment, the DF3/MF3 discards the initial CC data packet (step S4), and sends only the HI3 CC header to LEMF (step S5).

Discarding of the initial CC data packet may be instructed by the ADMF.

The HI3 CC header is actually the new type of the IRI. That is, LEMF receives only IRI. This is correct, because LEA was entitled to receive only IRI.

It is noted that according to the first embodiment, the ADMF would instruct the GSN to execute the IRI-only interception. Rather, the ADMF would instruct the DF/MF to do so. Namely, according to the prior art, once the DF3/MF3 receives X3 interface CC message, the DF3/MF3 would encapsulate the initial CC data packet by HI3 CC header, thus forming an HI3 CC message which would be sent to the LEMF.

However, according to the first embodiment, the initial CC data packet (i.e., the payload) is discarded. Thus, the CC data is not visible to LEMF.

According to a modification of the first embodiment, DF3/MF3 may optionally in addition look into the IP header of the targets CC data packet. In such a solution, DF3/MF3 would extract additional IRI data, relevant for LEA, such as IP addresses. Therefore, HI3 CC header would be amended by this additional data, which would make the HI3 IRI much more informative. This optional functionality would require extra processing efforts by the DF3/MF3 implementation.

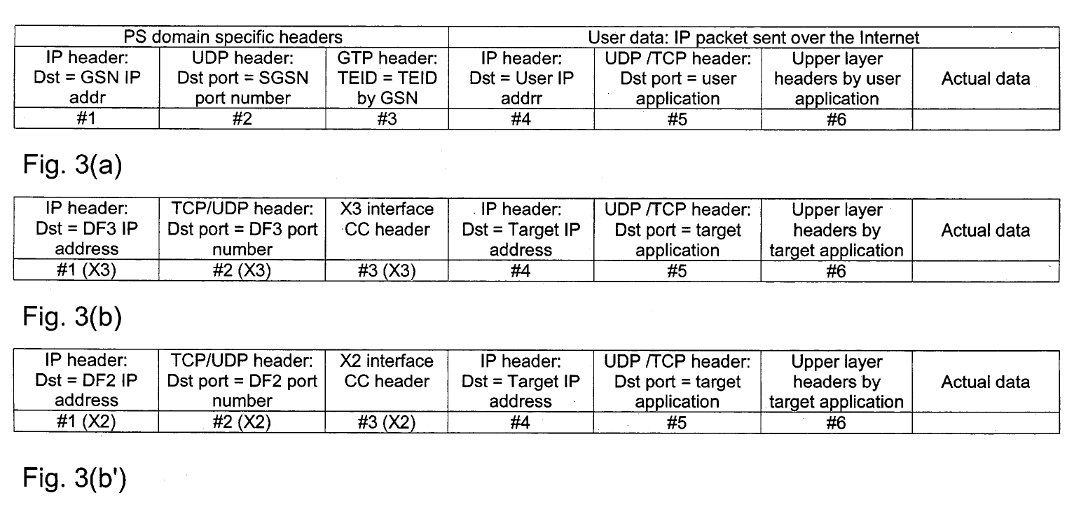

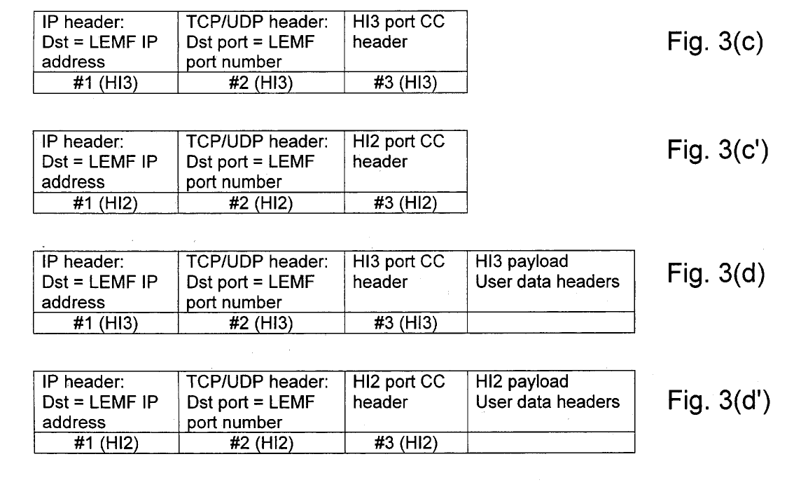

In the following, the headers used according to the first embodiment are described in more detail by referring to FIGS. 3(a) to 3(c). Figures illustrate layer 3 and upper layer headers only.

FIG. 3(a) illustrates the format in which GPRS or PS domain handle the user's (target's) data, which is sent across the Gn interface in GPRS. As shown, the format comprises a user data part which is the actual IP packet sent over the Internet, and PS domain specific headers. The user data part comprises the actual data (i.e., the payload) and several headers #4 to #6. An IP header #4 indicates the destination address, which is in this case the IP address of a user. An UDP/TCP header #5 indicates the destination port, which is in this case the number of the user application. Upper layer headers #6 are inserted by the user application. The PS domain specific headers comprises an IP header #1 indicating the destination address of a GSN or RNC (here, the IP address of the SGSN), a TCP/UDP header #2 indication the destination port (here, the port number at the SGSN) and an GTP header #3 indicating a TEID (here the TEID requested by the SGSN).

According to the first embodiment, the GSN may optionally be instructed to look into the #4 header, i.e., into the IP header.

FIG. 3(b) illustrates the format in which the intercepting GSN sends the CC message across the X3 interface to DF3. As also described above, this message is assembled by adding a X3 interface CC header #3(X3) to the user data part and by adding an IP header #1(X3) indicating the IP address of the DF3 as the destination address and a TCP/UDP header #2(X3) indicating the port number at the DF3 as the destination port.

FIG. 3(c) illustrates the format in which the DF3 sends the new type of IRI across the HI3 port to LEMF. This message is assembled by adding an IP header #1(HI3) indicating the IP address of the LEMF as the destination address and a TCP/UDP header #2(HI3) indicating the port number at the LEMF as the destination port to the HI3 interface CC header #3(HI3). Only the thus assembled HI3 CC message (consisting only of the headers #1 (HI3), #2(HI3) and #3(HI3) is sent to the LEMF.

As an alternative to the first embodiment, the DF3 may also include some of the user data headers #4 to #6 into the message sent to the LEMF. The corresponding format is shown in FIG. 3(d). In particular, the IP header #4 of the target could be included. Moreover, the upper layer headers #6 which are inserted by the target's application could be included since in this case the LEMF could monitor the details of kinds of services used by the target.

Therefore, according to the first embodiment, the DF3 is instructed to send either none, or optionally only the IP header (#4) to LEMF, and to discard the rest of the CC message which was sent over the X3 interface to the DF3. That is, of the user data part only the IP header is sent to the LEMF via the HI3 port.

Summarizing, according to the first embodiment, a simple solution is provided. Normally, once a DF3/MF3 receives the X3 interface CC message shown in FIG. 3(b), DF3/MF3 shall replace the X3 header by a HI3 header, add respective TCP/UDP and IP headers to each initial CC data packet and send the aggregated data packet (not shown) to an LEMF. However, in case only IRI may be sent to the LEMF (i.e., a look into the actual data is not permitted), the DF3/MF3 shall compose and send only a CC header to the LEMF (i.e., the message shown in FIG. 3(c)).

In the following, a preferred implementation of the present first embodiment is described by referring to the respective 3GPP specification (TS 33.108v5.1.0). In particular, the relevant parts of the specification are described in the following, and also the necessary changes of them are emphasized. In particular, service aspects (stage 2) and protocol level (stage 3) are described.

According to the preferred implementation of the first embodiment, formats of IRI and CC sent across the HI2 and HI3 interfaces may differ from X-interface counterparts. Hence, in principle it is possible to fine tune IRI and CC definitions for HI interfaces. This, in turn may require to fine tune the definitions of the HI2 and HI3.

Thus, according to the preferred implementation of the first embodiment, a new IRI type is defined. This special type of IRI shall be sent across the HI3 port. HI3 port definition has been modified.

Thus a definition of a new IRI type is introduced. This special type of IRI shall be sent across the HI3 port. Therefore, a modified version of the HI3 port definition has been provided.

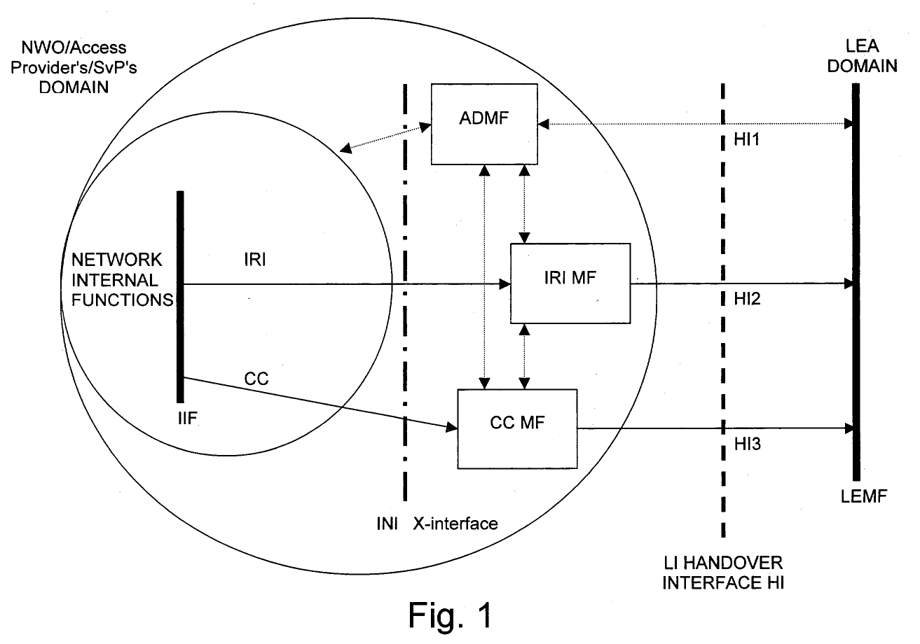

First, an overview of the handover interface is given. The structure is based on that shown in FIG. 1.

The generic handover interface adopts a three port structure such that administrative information (HI1), intercept related information (IRI), and the content of communication (CC) are logically separated.

HI2 shall transport the IRI.

HI3 shall transport the CC, and, in particular according to the first embodiment, optionally a special type of IRI.

FIG. 1 shows a block diagram with the relevant entities for Lawful Interception.

The outer circle represents the NWO/AccessProvider/SvP's domain with respect to lawful interception. It contains the network internal functions, the internal network interface (INI), the administration function and the mediation functions for IRI and CC. The inner circle contains the internal functions of the network (e.g. switching, routing, handling of the communication process). Within the network internal function the results of interception (i.e., IRI and CC) are generated in the Internal Interception Function (IIF).

The IIF provides the Content of Communication (CC) and the Intercept Related Information (IRI), respectively, at the Internal Network Interface (INI). For both kinds of information, mediation functions may be used, which provide the final representation of the standardized handover interfaces at the NWO/AccessProvider/SvP's domain boundary.

It is noted that FIG. 1 shows only a reference configuration, with a logical representation of the entities involved in lawful interception and does not mandate separate physical entities. Moreover, the mediation functions may be transparent.

The handover interface port 2 shall transport the IRI from the NWO/AccessProvider/SvP's IIF to the LEMF.

The delivery shall be performed via data communication methods which are suitable for the network infrastructure and for the kind and volume of data to be transmitted.

The delivery can in principle be made via different types of lower communication layers, which should be standard or widely used data communication protocols.

The individual IRI parameters shall be coded using ASN.1 and the basic encoding rules (BER) (as defined in TS 33.108). The format of the parameter's information content shall be based on existing telecommunication standards, where possible.

The individual IRI parameters have to be sent to the LEMF at least once (if available). The IRI records shall contain information available from normal network or service operating procedures. In addition the IRI records shall include information for identification and control purposes as specifically required by the HI2 port.

The IIF is not required to make any attempt to request explicitly extra information which has not already been supplied by a signalling system.

The port HI3 shall transport the content of the communication (CC) of the intercepted telecommunication service to the LEMF. The content of communication shall be presented as a transparent en-clair copy of the information flow during an established, frequently bi-directional, communication of the interception subject.

An appropriate form of HI3 depends upon the service being intercepted. According to the first embodiment, as a national option HI3 may transport a special type of IRI as well. This type of IRI shall be coded using either ASN.1 and the basic encoding rules (BER), or TLV, as specified in the following.

The HI2 and HI3 are logically different interfaces, even though in some installations the HI2 and HI3 packet streams might also be delivered via a common transmission path from a MF to a LEMF. It is possible to correlate HI2 and HI3 packet streams by having common (referencing) data fields embedded in the IRI and the CC packet streams.

Thus, in the definition of the IRI for packet domain, as a national option, an additional type of IRI may be defined, which contains only the CC header. This special type of IRI shall be send across the HI3 port.

Furthermore, the HI3 CC definition has to be changed such that is comprises HI3 CC and IRI definition.

In particular, the CC PDU (Contents of Communication Protocol Data Unit) has to be redefined such that the payload size is defined as including 0 as the length of the payload:

| CC-PDU ::= SEQUENCE | |
|---|---|
| { | |
| uLIC-header | [1] ULIC-header, |
| payload | [2] OCTET STRING (SIZE (0.. 65535)) |
| } | |

Namely, for the IRI sent across the HI3, it is possible to either send only uLIC-header (UMTS Li Correlation Header (ULIC)), or uLIC-header with the payload, which has ‘0’ length. The uLIC header is the HI3 CC header sent from the DF3/MF3 across the HI3 interface port to the LEMF.

The ULIC header has to be defined such that it may represent the IRI sent across the HI3.

| ULIC-header ::= SEQUENCE | |
|---|---|
| { | |
| hi3DomainId | [0] OBJECT IDENTIFIER, |
| | (3GPP HI3 Domain) |
| version | [1] Version, |
| IIID | [2] LawfulInterceptionIdentifier |
| | OPTIONAL, |
| correlation-Number | [3] GPRSCorrelationNumber, |
| timeStamp | [4] TimeStamp OPTIONAL, |
| sequence-number | [5] INTEGER (0..65535), |

| | |
|---|---|
| t-PDU-direction | [6] TPDU-direction, |
| ...} | |

In the following, the definition of ULIC header is described. The currently used ULIC-header version 1 is defined in ASN.1 and is encoded according to BER. It contains the following attributes:

ULIC header version (version)

set to version 2.

lawful interception identifier (LIID, optional)

sending of lawful interception identifier is application dependant; it is done according to national requirements.

correlation number (correlation-Number)

The correlation number is unique per PDP context and used for a correlation of CC with IRI and/or a correlation of different IRI records within one PDP context.

time stamp (timeStamp, optional),

sending of time stamp is application dependant; it is done according to national requirements.

sequence number (sequence-number).

Sequence Number is an increasing sequence number for tunneled T-PDUs. Handling of sequence number is application dependent; it is done according to national requirements (e.g. unique sequence number per PDP-context).

TPDU direction (t-PDU-direction)

indicates the direction of the T-PDU (from the target or to the target).

The ULIC header is followed by a subsequent payload information element. Only one information element is allowed in a single signalling message.

For IRI sent across HI3 port:

Only the ULIC header is sent;

The ULIC header may followed by a subsequent payload information element. In such case, the length of the payload information element shall be set to ‘0’.

Moreover, the usage of the FTP has to be modified. Namely, FTP shall be used to transfer CC across the HI3 port. As a national option, FTP may be used to transfer special type of IRI across the HI3 port. In such case, the value of the PayloadLength field in the CC header shall be set to ‘0’.

In addition, a new file type has to be defined for FTP. The current file naming method A) defined is

<LIID>_{—}<seq>.<ext>

LIID is the lawful interception identifier, which is assigned for each target identity related to an interception measure.

Seq=integer ranging between [0 . . . 2\hat{ }64-1], in ASCII form (not exceeding 20 ASCII digits), identifying the sequence number for file transfer from this node per a specific target.

Ext=ASCII integer ranging between [“1” . . . “7”.] (in hex: 31H . . . 0.37H), identifying the file type. The possible file type codings for intercepted data are shown in table C.1. But for the CC across the HI3 interface, only the types “2”, “4”, and “6” are possible.

According to the first embodiment, the ASCII value “1” shall be used for the IRI sent across the HI3 port. The following table illustrates the possible file types.

| File types that the LEA may get | Intercepted data types |
|---|---|
| “1” (in binary: 0011 0001) | IRI |
| “2” (in binary: 0011 0010) | CC(MO) |
| “4” (in binary: 0011 0100) | CC(MT) |
| “6” (in binary: 0011 0110) | CC(MO&MT) |

Thus, the least significant bit that is ‘1’ in file type 1, is reserved for indicating IRI data as created according to the first embodiment.

The remaining bits are not under scope of the present embodiment, and a detailed description is omitted here. Nevertheless, it is referred to the above-mentioned 3GPP specification (TS 33.108v5.1.0).

It is noted that the above detailed description of modifications to the 3GPP specification (TS 33.108v5.1.0) are only an example for an implementation of the first embodiment. The first embodiment can also be implemented in different ways, as long as only the header of the intercepted data packet is sent to a monitoring entity (e.g., LEMF), without sending the payload of the intercepted data packet.

Second embodiment

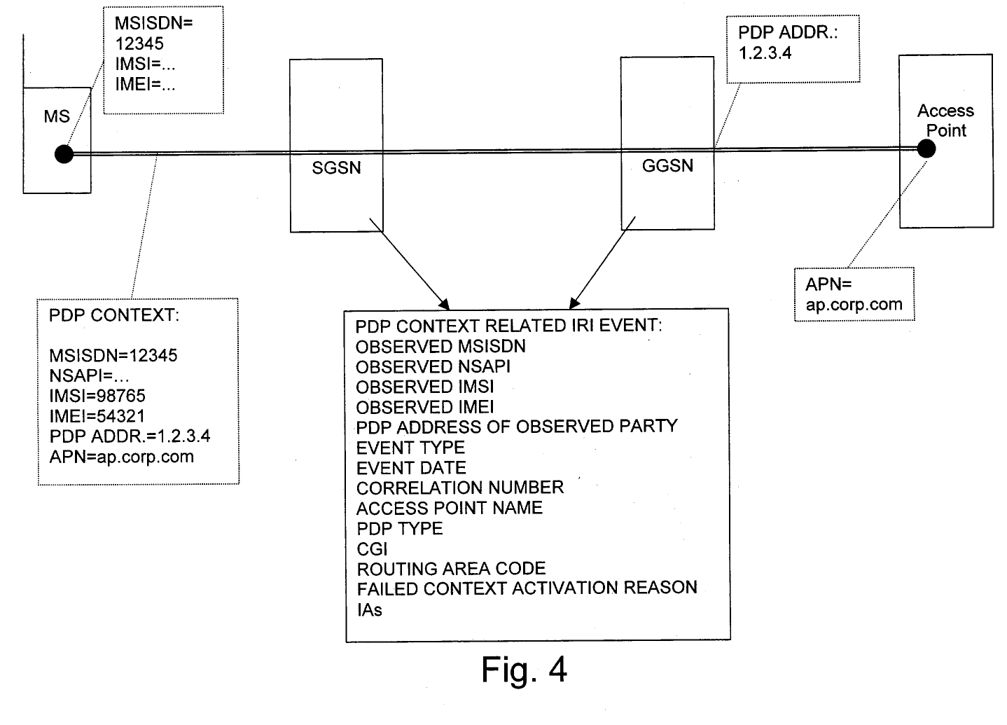

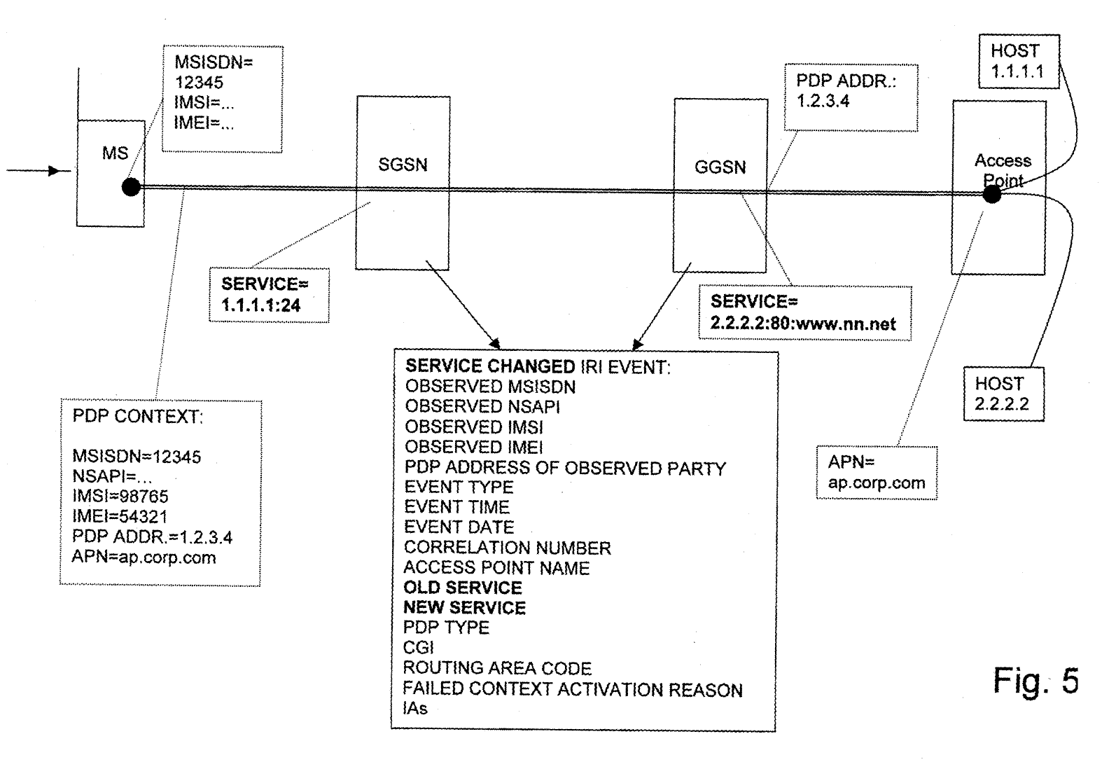

In the following, a second embodiment of the invention is described by referring to FIGS. 4 and 5.

According to the second embodiment, the interception is carried out with respect to specific information. An example for such specific information can be service information. It is determined whether a predetermined event with respect to the specific information has occurred, and, if the predetermined event has occurred, a corresponding message to a monitoring entity (e.g., LEA) is sent. An example for the predetermined event may be the use of a new service. That is, it is monitored whether the target to be intercepted starts using a new service and/or changes the service currently used by the target.

In more detail, according to the second embodiment a new service specific PDP Context related information is produced for LEA in IRI events. This makes IRI events more useful in criminal investigation, and possibly decreases the amount of CC interception as the service information can be obtained already from a less heavy IRI interception.

The user authentication is a difficult problem while studying message passing in Internet. Criminals use many techniques such as proxies, address translation and anonymous servers—to hide their identity while using Internet. Among the tried techniques are new mobile data services such as GSM, GPRS and UMTS PS domain. Adding destination IP address and the type of connection (service) to IRI data makes user authentication in some cases possible for LEAs.

Currently, i.e., according to the prior art, the PDP Context related IRI events include PDP Context Activation, Start of interception with PDP context active and PDP context deactivation events. The following information about the user and his internet actions are given:

Observed MSISDN

Observed NSAPI

Observed IMSI

Observed IMEI

PDP Address of observed party

Event Type

Event Time

Event Date

Correlation number

Access point name

PDP type

CGI

Routing area code

Failed context activation reason

IAs

The MSISDN, IMSI and IMEI authenticate the mobile subscriber and the mobile equipment. The NSAPI identifies the PDP context in an MS if the subscriber has several simultaneous PDP contexts. The IP address reserved for the PDP context at the GSM/UMTS PS domain core network side is called PDP Address.

FIG. 4 shows an arrangement in which PDP context related information is intercepted.

In detail, the connection between a mobile station MS and an access point is conveyed via an SGSN and a GGSN. The MS is identified by MSISDN, IMSI and IMEI. The PDP context within the connection to the SGSN contains MSISDN (in this example, 12345), NSAPI, IMSI (here, e.g., 98765), IMEI (e.g., 54321), PDP address (e.g., 1.2.3.4) and APN (e.g., ap.corp.com). From the SGSN and/or the GGSN, the above described PDP context related IRI events are extracted.

As shown in FIG. 4, the data is sent from the PDP address to the Access Point. As shown in FIG. 4, currently PDP context related IRI events contain PDP address and Access Point Name.

In the following, the procedure according to the second embodiment of the invention is described by referring to FIG. 5 which illustrates the Service level IRI interception according to the second embodiment. In the figure, the new items introduced by the second embodiment are indicated in bold.

In general, the service can be identified for example by

Destination host name or IP address and the port number (in this case IP header and the protocol e.g. UDP or TCP header has to be studied):

An ftp connection to a certain host

A telnet connection to a certain host

An e-mail sending via a certain mail server

A web browsing in a certain http server

A more specific service identification could be (in this case certain user data headers need to be studied)

An ftp transfer of certain files

A web browsing in a certain URL

An e-mail sending to a certain recipients

FIG. 5 illustrates the principle according to the second embodiment. Only the differences to that structure according to FIG. 4 are described in the following.

The GSN nodes (SGSNs and GGSNs) collect the interception information (IRI and CC) and send it further. According to the second embodiment, for each PDP context that is under interception the GSNs keep track on the current service. The service can be as simple as a destination host IP address and port (e.g., 1.1.1.1:80, as illustrated in FIG. 5), or more complex as an HTTP URL (e.g., 2.2.2.2:80:www.nn.net, as illustrated in FIG. 5). The service level that is, intercepted is defined when the GSN starts the interception of a PDP context.

Each time a GSN notices that the service has changed, it generates a Service Changed IRI event (in addition to other PDP context related IRI event shown in FIG. 4). In addition to the PDP context information the IRI event contains at least the new service. It might also contain the old service for verification purposes.

The GSN has to study only data packets for the PDP contexts under interception. That is why the performance loss is not assumed to be significant. The needed processing capacity also depends on the number of the protocol headers that needs to be studied: it is light to find out that the user uses http protocol but heavier to find out which URL the user connects to. The ADMF needs to support service level IRI interception configuration. This is straightforward to implement. The DF has to support Service Changed IRI event; the implementation is straightforward, too.

Thus, according to the second embodiment, it is not necessary to study CC data (i.e., the actual data of the user part data as shown in FIG. 3(a), for example), which is according to the prior art the only way to get service information from the intercepted packets. Namely, often the CC data studying is impossible due to the lack of resources, or unnecessary due to too long delay. Knowing the service information as soon as possible is most useful for a LEA because in internet tracks seem quickly to disappear.

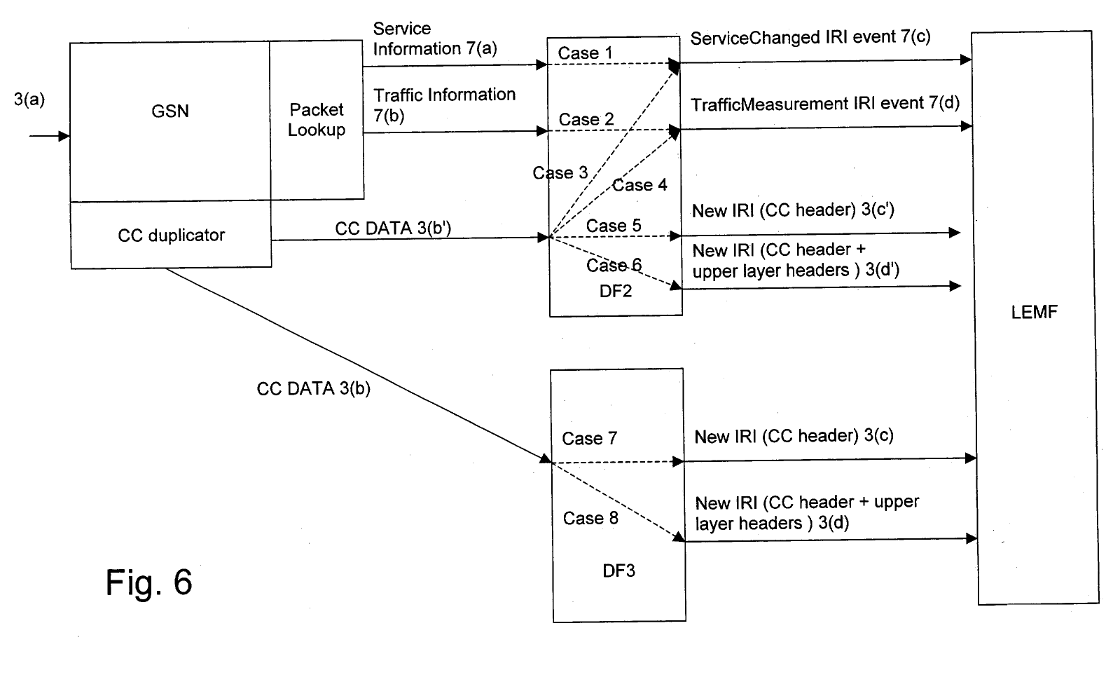

Next, the above procedure and some modifications of it are described by referring to FIGS. 6, 7, 8 and 9. FIG. 6 illustrates all possible message flows within a network according to the invention, i.e., not only that of the first and/or second embodiment but also of some modification. The procedures are described by referring to eight cases, i.e., case 1 to case 8, wherein cases 1 and 2 illustrate the procedure according to the second embodiment, cases 7 and 8 illustrate the procedure according to the first embodiment, and cases 3 to 6 illustrate some further modifications of the second embodiment.

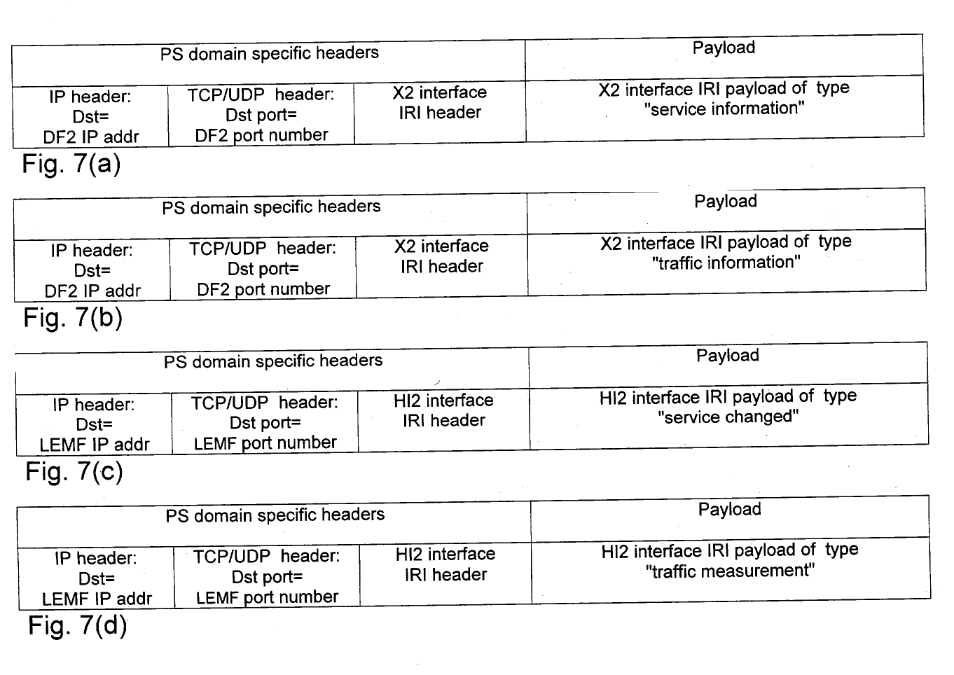

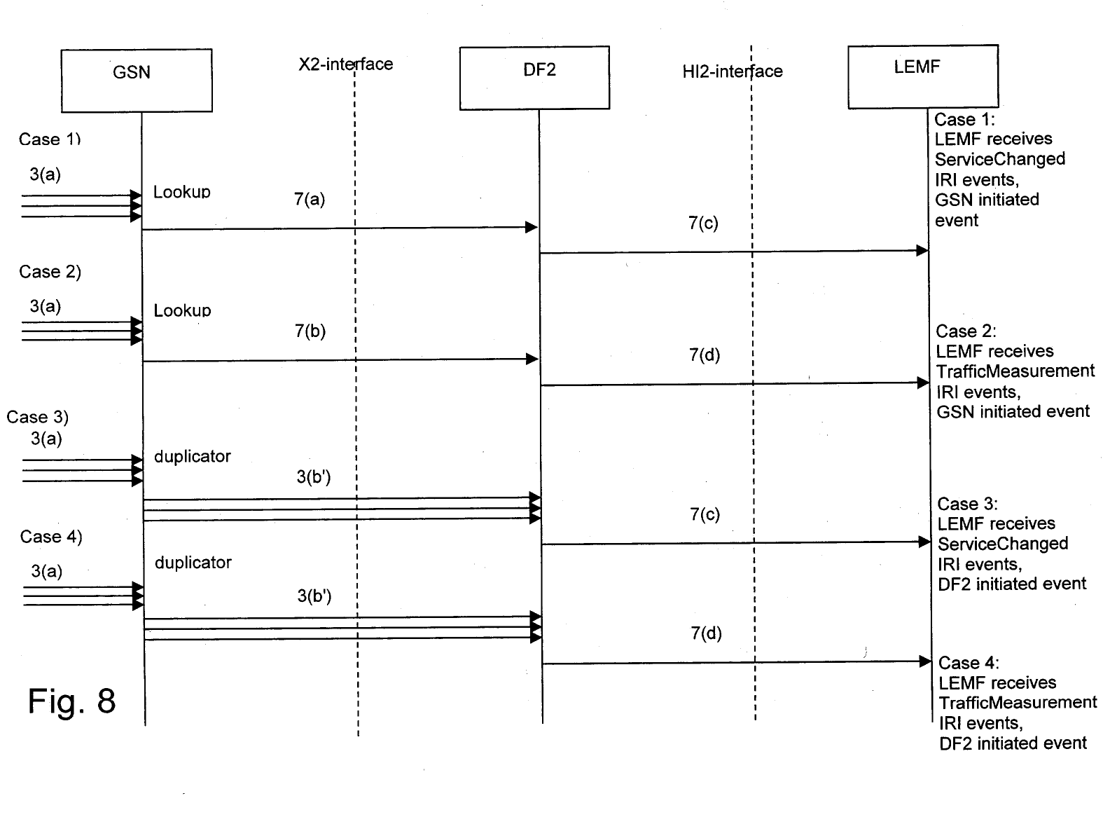

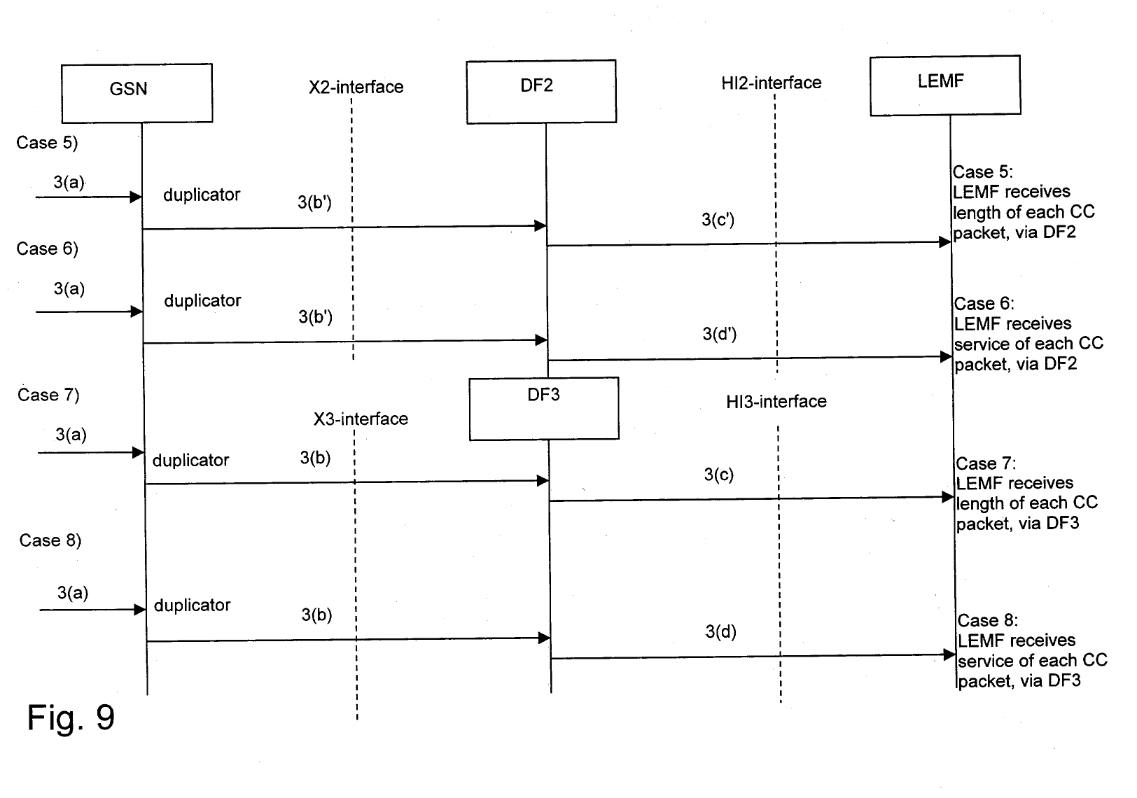

The cases 1 to 8 are also illustrated in FIGS. 8 and 9. FIG. 8 illustrates cases 1 to 4 in which the LEMF receives IRI events, that is, the LEMF does not receive a message for each CC packet. FIG. 9 illustrates cases 5 to 8, in which the LEMF receives CC header information, that is, the LEMF receives one message per CC packet. FIG. 7 illustrates the different data formats used in the cases 1 and 2.

As described above, the second embodiment is about to look at the CC data in order to find out the used service. That is, a packet lookup implementation of the GSN looks up to each packet under interception, collects information about ongoing packets and sends control messages to DF2 whenever some threshold values are met. This is illustrated in FIG. 6 by case 1. That is, service information is sent from the packet lookup implementation to the DF2 (case 1), which generates the Service Changed IRI event when a new service is used.

The second embodiment can also be extended such that it can deal also with traffic measurements as in the first embodiment. According to the second embodiment, this means that a new IRI event TrafficMeasurement should be generated when the byte/packet count extends a predefined threshold value (configured as the subscriber is put under interception) or a predefined timer expires. That is, the packet lookup implementation of the GSN (as illustrated in FIG. 6 by case 2) is modified such that it can measure the amount of traffic generated by the target to be intercepted (a simple counter will do).

Such a process is illustrated in FIG. 6 by case 2. That is, traffic information is sent from the packet lookup function to the DF2 (case 2), which generates the TrafficChanged IRI event when the threshold is reached or exceeded.

In the following, the formats of messages used according to the second embodiment are described by referring to FIGS. 7(a) to 7(d). The use of the formats is correspondingly indicated in FIG. 6 by referring to the respective figure.

FIG. 7(a) shows the format of a message sent to the DF2 when a predetermined event occurs, in this case, when a service is changed. The payload of the message comprises X2 interface IRI payload of type “service information”. The service information is obtained by studying user data headers (not user data payload). The headers of the message are PS domain specific headers and comprise an IP header (destination address is IP address of DF2, protocol is TCP, UDP, . . . ), a protocol header (destination port at DF2) and an X2 interface IRI header.

FIG. 7(b) shows the format of message sent to the DF2 in case traffic information are observed. Here, the PS domain specific headers are the same as in the format according to FIG. 7(a), and only the payload is different. Namely, the payload comprises X2 interface IRI payload of type “traffic information”. The traffic information is obtained, for example, by studying user data payload length, as described above.

FIG. 7(c) shows the format of the message sent to the LEMF via the HI2 interface. This message is sent when the message shown in FIG. 7(a) is received, i.e., when the GSN informs the DF2 that the service has changed.

The payload comprises the HI2 interface IRI payload of type service changed. That is, the IRI ServiceChanged Event is incorporated in this payload.

The message contains the following PS domain specific headers: a IP header (destination address is the IP address of the LEMF, protocol is TCP, UDP etc.), a protocol header (destination port at the LEMF) and a HI2 interface IRI header.

FIG. 7(d) shows the case regarding the traffic measurement, i.e., when the threshold value is exceeded and the message shown in FIG. 7(b) is received by the DF2. The headers of this message are the same. However, the payload comprises the HI2 interface IRI payload of type traffic measurement.

In addition, in order to give a complete overview of the present application, FIG. 6 shows also the messages according to the first embodiment. These are indicated by cases 7 and 8.

Namely, the user data to be intercepted are supplied to the GSN and are in the format as shown in FIG. 3(a). A CC duplicator function extracts the CC data and sends it to the DF3. The format used here is shown in FIG. 3(b). The CC header shown in FIG. 3(c) is then sent to the LEA, as illustrated by case 7 in FIGS. 6 and 9.

According to the first embodiment, the CC headers may in addition contain data extracted from the IP header of the target's datagram, namely, the upper layers headers, as described above in connection with the first embodiment. The corresponding data format used in case 8 is illustrated in FIG. 3(d), according to which the message comprises a payload containing the upper layer headers.

In addition, FIG. 6 illustrates modifications of the second embodiment, wherein some features of the first embodiment are combined with the second embodiment.

In particular, case 3 shows a procedure in which the CC data duplicated by the CC duplicator function of the GSN are not sent to the DF3 but to the DF2. The corresponding data format is shown in FIG. 3(b′). The format is similar to that of FIG. 3(b) with the exception that an X2 interface CC header is inserted and the IP header comprises the DF2 IP address as destination address and the TCP/UDP header comprises the DF2 port number as the destination port.

In this case, the DF2 is adapted to extract data regarding service information from the CC data. When a change of service occurs, the DF2 creates a ServiceChanged IRI event which is the same as that described in connection with case 1 (data format shown in FIG. 7(c)).

A similar modification as in case 2 is shown in case 4. That is, the DF2 is adapted to extract traffic information and to generate a TrafficMeasurement IRI Event upon exceeding a threshold, for example. The TrafficMeasurement IRI event is the same as that in case 2, and the data format thereof is shown in FIG. 7(d).

It is noted that in cases 1 to 4 only an IRI event is sent, that is, the messages are not sent to the LEMF on reception of every CC packet. In detail, in case 1 and 2 the LEMF receives ServiceChanged IRI events or TrafficMeasurement IRI events, respectively, and the procedure for creating these events is initiated by the GSN (due to the service information or the traffic information). In cases 3 and 4, the LEMF receives the ServiceChanged IRI events or the TrafficMeasurement IRI Events, but the procedure for creating these events is initiated by the DF2, since all CC data are forwarded to the DF2 which performs monitoring of the CC data.

Case 5 shows an example in which the CC header for each packet is delivered to the LEMF by using the DF2, instead of DF3 as described in the first embodiment and in case 7. That is, the CC headers cannot only be delivered via DF3 to the LEMF (as described above with connection to the first embodiment), but they can also be delivered via DF3. In particular, the CC data are received by the DF2 in the data format shown in FIG. 3(b′). From these CC data, the DF2 creates a new IRI similar to that according to the first embodiment, i.e., case 7. The data format thereof is shown in FIG. 3(c′), which is logically similar to that shown in FIG. 3(c) with the exception that a HI2 port CC header is included instead of a HI3 port CC header. It is noted that although the data formats are logically similar, the actual formats can be different at HI2 and HI3 (they may e.g. use different encoding).

Case 6 shows the modification that also user data headers are included in the message, similar to case 8. In case 6, the data format shown in FIG. 3(d′) is used which is logically similar to that of FIG. 3(d) with the exception that a HI2 port CC header instead of a HI3 port CC header is used.

It is noted that in cases 5 to 8 the LEMF receives CC headers for each CC packet. In particular, in cases 5 and 6, the LEMF receives traffic information (e.g., length) and service information of each CC packet via DF2. In cases 7 and 8, the LEMF receives traffic information (e.g., length) and service information of each CC packet via DF3.

Thus, according to the above modifications of the first and second embodiments (i.e., in cases 3, 4, 5 and 6), also the CC data duplicator implementation may be used that first sends all CC data to DF2. The DF2 then analyses the data and sends IRI events accordingly. That is, the DF2 creates the ServiceChanged IRI event and/or the TrafficMeasurement IRI event in response to the received CC data (cases 3 and 4), or sends the new IRI comprising the CC headers (cases 5 and 6).

Third Embodiment

In the embodiments described above, the packets of a target are intercepted in order to obtain information with respect to services, for example. However, it is also possible to refer to existing databases within a serving network node (e.g., GSN) in order to obtain such information. This process is described in the following as a third embodiment.

In particular, a so-called Charging Data Record (CDR) is provided in a GSN, as defined in 3GPP TS 32.215v5.1.0, for example. GSNs generate and temporarily store CDRs for all customers. CDRs can be generated in many ways. Basically, GSNs count packets and calculate payload volumes. Among other fields, the CDR may contain List of Traffic Data Volumes (exchanged data volume) and Duration (duration of the given record) information elements.

Thus, in case the information provided by the CDR is sufficient for a monitoring entity such as LEMF, only the information of the CDR could be transmitted to the LEMF without the necessity to perform an interception of the data packets. For example, the LI unit of a GSN can do a simple CDR lookup and send this particular type of IRI to LEMF via DF/MF.

In this way, the handling of the connection information can be very easy and simple, since the CDR is provided in the GSN already now according to current standards.

According to the invention, the following advantages are achieved:

LEA obtains more useful information in IRI events.

LEA can obtain service more easily because needs not to analyse CC data.

LEA can obtain service more quickly because needs not to analyse CC data.

LEA obtains service even if CC interception is not authorised.

Operator needs less often perform CC interception for LEA and so improves GSN capacity.

The DF/MF has to transfer less CC data to LEA.

IRI data in circuit switched and packet switched environment is more close with each other.

The above description and accompanying drawings only illustrate the present invention by way of example. In particular, the embodiments can be freely combined. For example, the CC headers may be delivered to the LEMF via DF2 and DF3. In this way, the CC headers may be delivered to the LEMF via DF2 or DF3 depending on the operation load on DF2 and DF3, for example. In addition, CC headers and IRI events may be forwarded to the LEMF, such that the LEMF obtains more data.

Furthermore, the features according to the embodiments can be implemented by considering the system architecture. That is, it can be considered how the feature is easier to implement or how it uses less system process/network capacity.

The embodiments and their modifications and/or combinations may vary within the scope of the attached claims.

What is claimed is:

1. A method for handling connection information in a communication network, comprising the steps of:
intercepting a data packet sent from/to a target (S1),
composing a header for the intercepted data packet (S4), and
sending the header to a monitoring entity (S5).

2. The method according to claim 1, wherein the header is composed and the payload of the intercepted data packet is discarded.

3. The method according to claim 1, wherein the composed header is sent to the monitoring entity via an interface dedicated to sending contents of communication messages.

4. The method according to claim 1, wherein the composed header is sent to the monitoring entity via an interface dedicated to sending interception related information messages.

5. The method according to claim 1, wherein the intercepted data packet is transmitted via an X interface, and
the intercepting step (S1) comprises the step of
assembling an X contents of communication message by adding an X interface header to the intercepted data packet (S2), and
the composing step (S4) comprises the steps of
extracting the intercepted data packet from the X contents of communication message (S3),
creating a HI contents of communication header (S4) and
discarding the intercepted data packet.

6. The method according to claim 5, wherein the X interface is a X3 interface, and the HI interface is a HI3 interface.

7. The method according to claim 5, wherein the composed header is included into an interception related information (IRI) message and sent over a HI2 interface to the monitoring entity.

8. The method according to claim 1, wherein the composed header forms a specific type of interception related information (IRI).

9. The method according to claim 1, further comprising the step of:
examining the frequency how often services are used by the intercepted target based on a plurality of composed headers, this step being performed in the monitoring entity after the sending step (S5).

10. The method according to claim 1, wherein the composing step comprises the steps of:
extracting an user data header from the intercepted data packet, and
adding the extracted header to the composed header to be sent to the monitoring entity.

11. A method for handling connection information in a communication network, comprising the steps of:
intercepting data packets sent from/to a target,
examining the intercepted data packets with respect to specific information,
determining whether an predetermined event with respect to the specific information has occurred, and
if the predetermined event has occurred, sending a corresponding message to a monitoring entity.

12. The method according to claim 11, wherein the specific information contains service information, and the predetermined event is the use of a new service.

13. The method according to claim 11, wherein the specific information contains traffic information, and the predetermined event is exceeding a predefined threshold of the amount of traffic.

14. The method according to claim 11, wherein the message sent to the monitoring entity is sent via an interface dedicated to sending interception related information.

15. The method according to claim 14, wherein the interface is a HI2 interface.

16. The method according to claim 11, wherein the message to be sent to the monitoring entity forms a specific interception related information (IRI) event.

17. The method according to claim 11, further comprising the steps of:
extracting a header of the intercepted data packet, and
including the extracted header into the message to be sent to the monitoring entity.

18. The method according to claim 17, wherein the examining step is performed by examining the extracted header with respect to specific information.

19. The method according to claim 11, wherein the examining step is performed in a packet lookup function of a network node.

20. The method according to claim 11, wherein the intercepted packets are delivered from a contents of communication duplicator function of a network node, and the examining step is performed in delivery function (DF2).

21. A system for handling connection information in a communication network, comprising:
an intercepting means for intercepting a data packet sent from/to a target,
a composing means for composing a header for the intercepted data packet, and
a sending means for sending the composed header to a monitoring entity.

22. The system according to claim 21, wherein the composing means is adapted to compose the header and to discard the payload of the intercepted data packet.

23. The system according to claim 21, wherein the sending means is adapted to send the composed header to the monitoring entity via an interface dedicated to sending contents of communication messages.

24. The system according to claim 21, wherein the sending means is adapted to send the composed header to the monitoring entity via an interface dedicated to sending interception related information messages.

25. The system according to claim 21, wherein the intercepting means is a contents of communication duplication function of a network node which is adapted to send the intercepted data packet via an X interface to the extracting means, wherein
the intercepting means is adapted to assemble an X contents of communication message by adding an X interface header to the intercepted data packet,
the composing means is adapted to extract the intercepted data packet from the X contents of communication message,
to create a HI contents of communication header and
to discard the intercepted data packet.

26. The system according to claim 25, wherein the X interface is a X3 interface, and the HI interface is a HI3 interface.

27. The system according to claim 21, wherein the sending means is adapted to include the composed header into an interception related information (IRI) message and to send the message over a HI2 interface to the monitoring entity.

28. The system according to claim 21, wherein the composed header forms a specific type of interception related information (IRI).

29. The system according to claim 21, wherein the monitoring entity is adapted to examine how often services are used by the intercepted target based on a plurality of composed headers.

30. The system according to claim 21, wherein the composing means is adapted to extract an user data header from the intercepted data packet and to add the extracted header to the composed header to be sent to the monitoring entity.

31. A system for handling connection information in a communication network, comprising:
an intercepting means for intercepting data packets sent from/to a target, and
a controlling means adapted to examine the intercepted data packets with respect to specific information, to determine whether a predetermined event with respect to the specific information has occurred, and to send, if the predetermined event has occurred, a corresponding message to a monitoring entity.

32. The system according to claim 31, wherein the specific information contains service information, and the predetermined event is the use of a new service.

33. The system according to claim 31, wherein the specific information contains traffic information, and the predetermined event is exceeding a predefined threshold of the amount of traffic, the control means being adapted to measure the amount of traffic.

34. The system according to claim 31, wherein the control means is adapted to send the message sent to the monitoring entity via an interface dedicated to sending interception related information.

35. The system according to clam 32, wherein the interface is a HI2 interface.

36. The system according to claim 31, wherein the message to be sent to the monitoring entity forms a specific interception related information (IRI) event.

37. The system according to claim 31, further comprising:
an extracting means for extracting a header of the intercepted data packet, wherein
the control means is adapted to include the extracted header into the message to be sent to the monitoring entity.

38. The system according to claim 37, wherein control means is adapted to examine the intercepted data packets with respect to specific information by examining the extracted header.

39. The system according to claim 31, wherein the examining means is a packet lookup function of a network node.

40. The system according to claim 21 or 31, wherein the intercepting means is a contents of communication duplicator implementation of a network node.

41. The system according to claim 40, wherein the a contents of communication duplicator function is adapted to deliver the intercepted packets to the examining means which is a delivery function (DF2).

42. The system according to claim 21, wherein the composing means is a delivery function and/or mediation function of a handover interface.

43. The system according to claim 21, wherein the sending means is a delivery function and/or mediation function of a handover interface.

44. The system according to claim 31, wherein the control means is a delivery function and/or mediation function of a handover interface.

45. A method for handling connection information in a communication network, comprising the steps of:
accessing a subscriber specific database of a target within a serving network node,
extracting information from the subscriber specific database with respect to specific information, and
sending the extracted information to a monitoring entity.

46. The method according to claim 45, wherein the subscriber specific database is a Charging Data Record (CDR) of the target.

47. The method according to claim 45, wherein the specific information comprise exchanged data volume and/or duration of the connection.

48. A system for handling connection information in a communication network, comprising:
an accessing means for accessing a subscriber specific database of a target within a serving network node, and
a controlling means for extracting information from the subscriber specific database with respect to specific information, and sending the extracted information to a monitoring entity.

49. The system according to claim 48, wherein the subscriber specific database is a Charging Data Record (CDR) of the target.

50. The system according to claim 48, wherein the specific information comprise exchanged data volume and/or duration of the connection.
